(19) United States
(12) Patent Application Publication
(10) Pub. No.: US 2021/0367459 A1
(43) Pub. Date: Nov. 25, 2021

(54) INTERCONNECTOR FOR STATOR OF ELECTRICAL MACHINE AND THE STATOR COMPRISING THE INTERCONNECTOR

(71) Applicant: VALEO EQUIPEMENTS ELECTRIQUES MOTEUR, Creteil Cedex (FR)

(72) Inventors: Hugues GERVAIS, Noisiel (FR); Michael HANQUEZ, Creteil (FR)

(21) Appl. No.: 17/397,759

(22) Filed: Aug. 9, 2021

Related U.S. Application Data
(63) Continuation of application No. 15/104,802, filed on Jun. 15, 2016, now abandoned.

(30) Foreign Application Priority Data
Dec. 20, 2013 (FR) 1363337

(51) Int. Cl. H02K 1/14; H02K 3/52; H02K 3/18

(52) U.S. Cl. CPC H02K 1/146; H02K 2203/09; H02K 3/18; H02K 3/522

(57) ABSTRACT

An interconnector having circular conductors for a stator of a polyphase rotary electric machine including a body having a winding provided with a plurality of coils each having input and output ends, the interconnector comprising a first portion including at least three circular conductors having an annular shape stacked axially on top of one another and electrically isolated from one another, and a second portion including at least one electrically insulated circular conductor having an annular shape. The first and second portions are intended for being installed on either side of the body of the stator. The circular conductors of the first portion and the circular conductors of the second portion have, on the inner periphery thereof, tabs projecting inwardly for welding the input ends and the output ends of the coils, respectively.

### FIELD OF THE INVENTION

The present invention concerns an interconnector for a stator of an electrical machine.

The present invention also concerns a stator of an electrical machine comprising an interconnector of this type.

The invention relates to the field of electrical machines such as electric motors, alternators or reversible alternators known as alternator-starters.

The invention has an application in the field of range extenders of electric vehicles. These range extenders comprise a low-power thermal engine which drives an alternator, which, when necessary, is designed to supply electrical energy to the supply batteries of the electric traction motor of the electric vehicle.

The invention can also be applied to alternators, alternator-starters, and electric motors.

### PRIOR ART

As is known, a rotary electrical machine, such as a vehicle alternator, a range extender of an electric vehicle, or an electric motor, comprises a housing which supports a stator on its inner periphery, and which supports centrally, via bearing means such as ball bearings and/or needle bearings, a shaft which is integral with a rotor fitted inside the stator.

This electrical machine comprises an armature and an inductor.

In the case of an alternator, for example of a motor vehicle, the stator can comprise a body in the form of a set of plates which supports a polyphase armature winding, whereas the rotor can comprise an inductor winding or magnets.

The polyphase winding can comprise a plurality of phases, for example three phases or more, which are connected to a voltage rectifier bridge, for example with diodes, or an inverter, in order to supply the consumers of the motor vehicle with direct current and recharge the vehicle battery.

The inductor rotor of the alternator come be a claw rotor comprising two magnet wheels with claws, with interposition of a core in one or two parts which support with electrical insulation an excitation winding, the ends of which are each connected electrically to a collector ring, on each of which a brush rubs. These brushes are connected to a voltage regulator. For further details, reference will be made for example to documents FR 2 676 873 and FR 2 710 197.

As a variant, the alternator is reversible, and comprises an inverter, which for example is provided with transistors of the MOSFET type, as described for example in document FR 2 745 444 to which reference will be made, this type of alternator being known as an alternator-starter, since it also makes it possible to function in electric motor mode, in particular in order to start the thermal engine of the vehicle.

As a variant, the rotor comprises permanent magnets, in the case of an alternator for example of the type described in document EP 0 803 962, an alternator-starter, or an electric motor with an inductor stator and an inverter, for example of the type described in document EP 0 831 580.

As a variant, the rotor is a rotor with projecting poles, and comprises a plurality of inductor windings, as described for example in document EP 1 362 407.

As a variant, the rotor comprises inductor windings and permanent magnets, as described in this document EP 1 362 407, interposed between its claws.

As a variant, the rotor is a claw rotor with permanent magnets, as described for example in document FR 2 793 085. As a variant, the rotor is a rotor with permanent magnets only.

The electrical machine can be without brushes, and comprise in their place an excitation alternator comprising an inductor stator and an induced rotor which are connected by a current rectifier bridge with an inductor winding of an alternator or of an electromagnetic retarder.

The rotary electrical machine can be cooled by means of at least one fan which is placed outside the housing or inside the housing, as in the aforementioned document FR 2 676 873. As a variant, the machine can be cooled by a coolant fluid which circulates in a channel provided in the housing, as described for example in documents FR 2 667 738 and FR 2 793 085.

As can be seen in FIG. 1, the stator can comprise a body 6, 10 in the form of a set of plates which is provided on its outer periphery with a head 6, which has on its inner periphery a plurality of teeth 10 facing radially towards the interior and delimiting notches between one another. Coils 9, with an electrically conductive wire wound around a notch insulator 1, are fitted on the teeth 10. The electric wire of a coil 9 is for example made of copper and/or aluminium covered with electrical insulation such as enamel. The insulator 1 is electrically insulating and is made for example of plastic material. This insulator comprises a body 2 provided with walls 4 which delimit a frame 5 with a globally rectangular form. This body 2 also comprises a front rim 7 which is situated on the inner side of the machine, and a rear rim 8 which is designed to be positioned against the inner periphery of the head 6. The walls 4 delimit together with the rims 7, 8 a groove for fitting of a coil 9. These coils 9 are connected electrically to one another in order to form the phases of the stator winding, as described for example in document FR 2 890 798, to which reference will be made for further details. This type of stator can be equipped with an interconnector, in order to connect the phases of the polyphase electrical machine, as described for example in application FR 12/55770 filed on 20 Dec. 2012. For further details, FIGS. 2 to 9 of this application FR 12/55770 will apply once more.

Thus, FIGS. 2a and 2b show views in perspective respectively of a set of plates of a stator and of a wound stator provided with an interconnector according to this application.

FIG. 3 is a view from above of the interconnector, whereas FIG. 4 represents a view in perspective of one of the conductors which have an annular form, and are for example circular, of the interconnector.

FIGS. 5 and 6 are views respectively in perspective and in transverse cross-section of the conductors which have an annular form, and are for example circular, which can be stacked and over-moulded in the interconnector.

FIG. 7 represents a detailed view in perspective of an interconnection lug of the interconnector.

FIG. 8 is a detailed view in perspective showing an indexing pin of the interconnector, with a system for guiding the coil insulator shown in perspective in FIG. 9.

In this application FR 12/55770, the stator 11 has an axis X and a body 12 which can be in the form of a set of plates made of ferromagnetic material extending perpendicularly to the axis X. These plates can be held together by rivets and/or welding beads. Hereinafter in the description, the orientations axial, radial and transverse will apply with reference to the axis X.

The body 12 has on its outer periphery a head 17, which can have a cylindrical form, and on its inner periphery it has a plurality of teeth 14 which face radially towards the interior, whilst being obtained from the inner periphery of the head 17. The head 17 can be forced, for example by being fitted, into the housing of the electrical machine, whereas the inner periphery of the teeth will delimit an air gap with the outer periphery of the rotor of the electrical machine. Notches 15 which are open towards the interior are present between two consecutive teeth 14 with parallel edges. The longitudinal edges of the teeth face axially.

As can be seen in FIG. 2a, preformed coils 19 are fitted on the teeth 14, such that two preformed coils 19 are fitted in a single notch 15. These coils 19 are made from an electrically conductive wire wound around a plurality of turns. The wire is made for example of copper and/or aluminium covered with an electrical insulator such as enamel. This wire is wound in a groove of an insulator 20 which is made of an electrically insulating material, for example plastic material such as PA 6.6, which can be reinforced by fibres, for example glass fibres. As can be seen in FIG. 9, this insulator comprises a body 201 formed by a frame 202 which is delimited by a front rim 203 spaced from the head 17, and a rear rim 204 designed to be supported against the inner periphery of the head 17.

This rear rim 204 is extended on one side by a heel 207 and on the other side by a fin 208 via a bending area 209. The fin 208 can be thicker than the heel 207 which is positioned placed against the base of a notch 15 constituted by a portion of the inner periphery of the head 17, in order to decrease the voltage drop between the coil 19 and the head 17. The fin 208 is designed to be turned down such as to be kept folded back by a front rim of an adjacent insulator 20, in order to constitute an electrically insulating wall between two adjacent coils 19. The rims 203, 204 and the frame 202 of the body 201 of a coil 19 define a groove for winding of the wire of the coil 19, which can have a round cross-section or as a variant a cross-section which is rectangular, square or in the form of a flattened part. This coil wire has two ends 191, 192 which are situated globally on the same circumference, on a free end side of a tooth 14 which is furthest from the head 17, as can be seen in FIG. 2b. A first end 191 of a coil 19 known as the “input end” is designed to be connected to the other inputs 191 in an alternating manner, in order to belong to one of the phases U, V, W of the polyphase electrical machine, which can be of the three-phase type. A second end 192 of this coil 19 known as the “output end” is designed to be connected to the neutral of the winding of the stator 11.

Each rim 203, 204 has two longitudinal borders with axial orientation and two borders with transverse orientation, which have a shorter length than the longitudinal borders. The longitudinal borders of the front edge 203 are configured at one of their ends 213 to act as a wire guide for each end 191, 192 of the coil 19. The frame 202 is designed to be fitted with its coil 19 on a tooth 14 which has a globally rectangular cross-section complementary to that of the inner periphery of the frame 202. The inner faces of the lower and upper walls of the frame 202 of the insulator 20 have blind grooves 211 which do not open out at the inner side of the electrical machine, in order to secure the frame 202 and the coil 19 on a tooth 14 by means of an impregnation varnish, which for example is based on epoxy resin, non-saturated polyester resin or silicon resin. It will be appreciated that it is possible to add accelerators in order to reduce the duration of impregnation, with the resin introduced in the liquid state into the grooves 211 being polymerised. It will be noted that the grooves 211 are not masked by the head 17.

The coils 19 are interconnected to one another in order to form the different phases of the polyphase electrical machine by means of an interconnector 22 with an axis X1 which is combined with the axis X when the connector is installed on the stator 11. For this purpose, the interconnector comprises at least four electrical conductors 31-34 which have an annular form, and are for example circular, stacked axially on one another and insulated against one another.

Each circular conductor 31-34 supports on its inner periphery electrically conductive lugs 36 which extend projecting towards the interior for welding of the ends 191, 192 of the coils 19.

The number of coils 19 can be equal to 15 in order to obtain good power of the electrical machine, whilst having a compact stator, each phase U, V, W of the three-phase winding comprising five lugs 36. It will be appreciated that this depends on the applications, and the number of coils 19 can be different from 15, in the knowledge that the machine can comprise more than three phases.

One 31 of the circular conductors, known as the neutral circular conductor, is designed to be connected to the neutral of the winding of the stator 11 of the machine, as can be seen for example in FIG. 1 of the aforementioned document EP 0 831 580, whereas three of the other circular conductors 32-34, known as the phase circular conductors, are each designed to be connected to a phase of the machine. The neutral circular conductor 31 thus comprises 15 lugs in this embodiment with 5 coils 19 per phase.

An assembly 47 (FIGS. 3 and 5) formed by a lug 36 of a neutral circular conductor 31 and a lug 36 of a phase circular conductor 32-34 is implanted such as to be positioned between the sides of a coil 19 of the stator 11, as can be seen for example in FIG. 2a. The ends 191, 192 of the assembly 47 are offset relative to one another. All of this is carried out in order to have enough space to grip a lug 36 and an end 191, 192 of a coil 19 by means of a welding electrode. For this purpose, the circular conductors 31-34 are electrically conductive, and are for example made of copper or another weldable metal material.

The circular conductors 31-34 have a globally annular form, and are embedded in a body 38 made of electrically insulating material, such as plastic material, for example PA 6.6 which is advantageously reinforced by fibres, such as glass fibres. As can be seen for example in FIG. 6, a thickness E, for example of 1.6 mm is present between the circular conductors.

The outer diameter of the connector 22 corresponds globally to the outer diameter of the circular conductors 31-34. This outer diameter is smaller than the outer diameter of the head 17. For example the outer diameter of the circular conductors is approximately 218.5 mm, whereas the inner diameter of the circular conductors is approximately 198.5 mm, this diameter being larger than that of the inner periphery of the teeth 14. The ends 191, 192 with axial orientation of the coils 19 are implanted on a circumference which is firstly at least equal to, and in this case larger than, that of the inner periphery of the teeth 14, and secondly smaller than the inner diameter of the circular conductors 31-34, and thus of the connector 22.

As can be seen in FIG. 7, each lug 36 comprises a portion in the form of an “L”, which is provided with a first arm 361 obtained from the inner periphery of a circular conductor 31-34, and extends towards the interior, and a second arm 362, which is perpendicular to the first arm 361. The free end of the lug 36 has a head 363 which is connected to one of the edges of the second arm 362. The head has a hollow curved form which is adapted to the cross-section of the conductive wire for welding of the end concerned 191, 192 of a coil 19. The hollow part of the head 363 extends globally perpendicularly to the first arm 361. The lugs 36 of the neutral circular conductors 31 face according to an axial direction, in a direction which is inverse in relation to the lugs 36 of the circular conductors 32-34 of the phases, such that all the lugs 36 of the interconnector 22 are situated globally at the same height as the ends 191, 192 of the coils 19. More specifically, as shown in FIG. 3, the lugs 36 of the circular conductors 31 face in the axial direction L1, whereas the lugs 36 of the circular conductors 32-34 face in the opposite axial direction L2.

Each circular phase conductor 32-34 comprises on its outer periphery a connection terminal 41-43 for connection to a power connector, which itself is connected to the rectifier bridge of an alternator or an inverter, such as that in documents EP 0 831 580 and FR 2 745 444. These terminals 41-43 are placed side-by-side, and have an end for example in the form of a “U”. These terminals 41-43 are rigid and have a small size.

The interconnector 22 also comprises indexing studs 53 for adjustment of the fitting of the interconnector 22 relative to the head 17 of the stator 11. These studs 53 with axial orientation comprise a rod which is designed to be inserted in, and each to cooperate with, a guide system supported by an associated coil insulator 19, as shown in FIG. 8. For this purpose, the insulator has two protuberances 54 between which the rod 53 penetrates.

This connector 22 has support feet 61, in this case four of them, which ensure positioning of the insulating body 38 of the interconnector above the coils 19, without touching them. These feet are implanted on the outer periphery of the body 38, as shown in FIG. 3. The feet are in the form of an “L” with a securing end obtained from the outer periphery of the body 38, and an end ending in a support 62 which is designed to be supported on the rim concerned of the head 17. The support 62 comprises for example holes for its securing on the head, for example by screwing, riveting, or by means of tie rods.

This type of connector is satisfactory. However, the assembly 47 of a single coil 19 formed by a lug 36 of a neutral circular conductor 31 and a lug 36 of a phase circular conductor 32-34 may not be spaced circumferentially as much as desired, which may fail to facilitate the welding operations by impeding the passage of the electrodes for welding of the ends 191, 192 of the coils 19 on the lugs 36.

It is therefore desirable to facilitate the operations of welding of the ends 191, 192 of the coils 19.

### OBJECTIVE OF THE INVENTION

The objective of the invention is to fulfil this requirement simply and economically.

Thus, according to the invention, an interconnector with circular conductors for a stator of a polyphase rotary electrical machine comprising a stator body which supports a winding provided with a plurality of coils, each of which has input and output ends, is characterised in that it comprises a first part comprising at least three circular conductors with an annular form stacked axially on one another and insulated electrically against one another, and a second part comprising at least one circular conductor with an annular form which is insulated electrically, the said first and second parts being designed to be implanted on both sides of the stator body, and in that the circular conductors of the first part and the circular conductor of the second part support on their inner periphery lugs which extend projecting towards the interior, for welding respectively of the input ends and output ends of the coils.

According to the invention, a stator of a rotary electrical machine equipped with coils is characterised in that it comprises an interconnector of this type.

Thanks to the invention, the inputs and the outputs of the coils are distributed on both sides of the body of the stator, which leaves more space for the welding operations. It is therefore possible to grip the ends 191, 192 and the lugs by means of welding electrodes without interference.

In addition, the interconnector according to the aforementioned application is not modified profoundly, since the number of its circular conductors is reduced, whilst having the possibility of retaining its structure. At least one circular conductor is added on the other side of the body of the stator of the electrical machine. These circular conductors can comprise feet or can be without them.

In addition, it is easily possible to increase the number of phases of the machine, and envisage fitting of the coils in the form of a triangle or a star. In the case of fitting in the form of a star, the second part of the connector has a plurality of circular conductors with connection terminals. This second part can comprise indexing pins which are designed to cooperate with guide systems, such as protuberances, supported by the coil insulators.

It is possible to standardise the coil insulators and provide them at each of their axial ends with guide hollows for receipt of an end of a coil and protuberances for receipt of an indexing stud of the interconnector.

It would undoubtedly have been possible to make the circular conductor of the second part of the connector, such as a neutral circular conductor, project towards the interior of the rotor, but this involves axial fitting of the rotor in the stator in a single direction. Thanks to the invention, it is possible to fit the rotor in the stator axially in both directions.

According to other characteristics taken in isolation or in combination:
the second part of the interconnector has a neutral circular conductor for fitting of the coils in star form;
the second part of the interconnector comprises two neutral circular conductors for fitting in parallel of two windings of the coils in star form;
the first part of the interconnector comprises six circular conductors;
the second part of the interconnector has a number of circular conductors which is equal to that of the first part of the interconnector for fitting of the coils in star form;
the first and the second part of the interconnector have similar forms;
the number of coils of the stator is more or less than 15;
the stator supports five coils per phase of the electrical machine;
the stator supports four coils per phase of the machine;
the input and output ends of the coils are implanted respectively at one and the other of the axial ends of the coils;
the ends of the coils are implanted on both sides of the body of the stator;
the ends of the coils are implanted on a circumference with a diameter which is at least equal to that of the inner periphery of the teeth of the stator, in order not to interfere with the rotor of the electrical machine;
the electrical machine is an alternator;
the electrical machine is an alternator-starter;
the electrical machine is an electric motor;
the electrical machine is a range extender of an electric vehicle;
the electrical machine has a voltage rectifier bridge or an inverter which is supported by the housing of the latter;
the interconnector is secured on at least one coil insulator;
the interconnector is secured on at least three insulators;
the interconnector comprises at least one clip which cooperates with an opening provided in a rear rim of the insulator;
the coils are coupled in the form of a triangle.

Other advantages will become apparent from reading the following description which is provided in a non-limiting manner, and with reference to the appended drawings.

### BRIEF DESCRIPTION OF THE DRAWINGS

The aforementioned FIG. 1 shows a coil insulator according to the prior art which is designed to be fitted around a tooth of the stator;

The aforementioned FIGS. 2a and 2b are views in perspective respectively of a stator alone and a wound stator which is provided with an interconnector according to the application FR 12/55770;

FIG. 3 is a view from above of the interconnector;

FIG. 5 represents a view in perspective of one of the circular conductors of the interconnector;

FIGS. 5 and 6 are views respectively in perspective and in transverse cross-section of the circular conductors of the stack of the interconnector;

FIG. 7 represents a detailed view in perspective of an interconnection lug of the interconnector;

FIG. 8 is a detailed view in perspective showing an indexing stud of the interconnector with a system for guiding of the coil insulator;

FIG. 9 is a view in perspective of a coil insulator;

FIG. 10 is a partial view in perspective, similar to FIG. 2b, of a wound stator provided with an interconnector in two parts according to the invention.

In the figures, the elements which are identical or similar will be allocated the same references.

### DESCRIPTION OF EMBODIMENTS OF THE INVENTION

In the description, elements which are common or similar to those of the application FR 12/55770 will be allocated the same references, with the content of this application FR 12/55770 being considered to form part of the description.

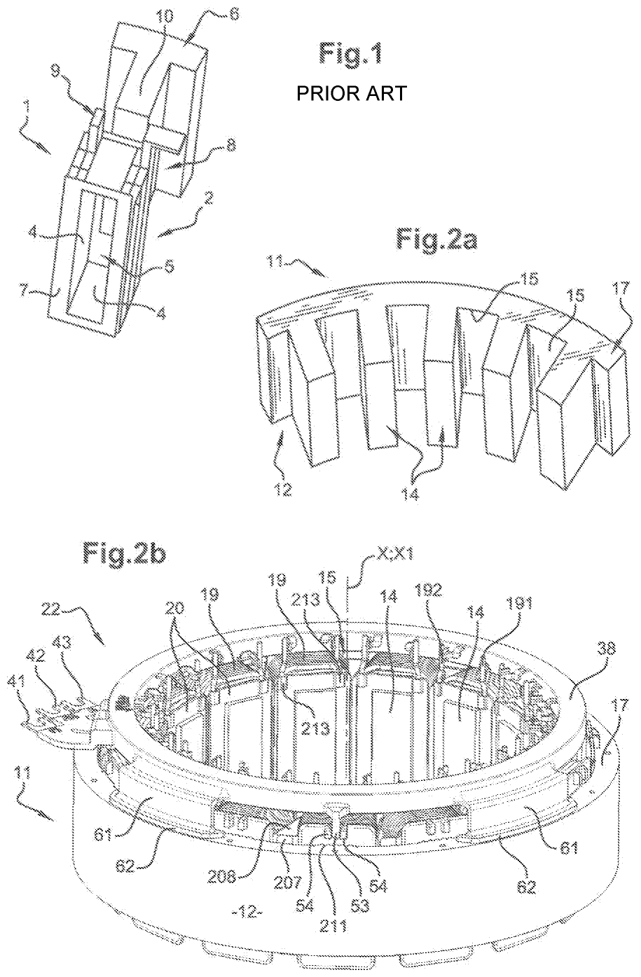

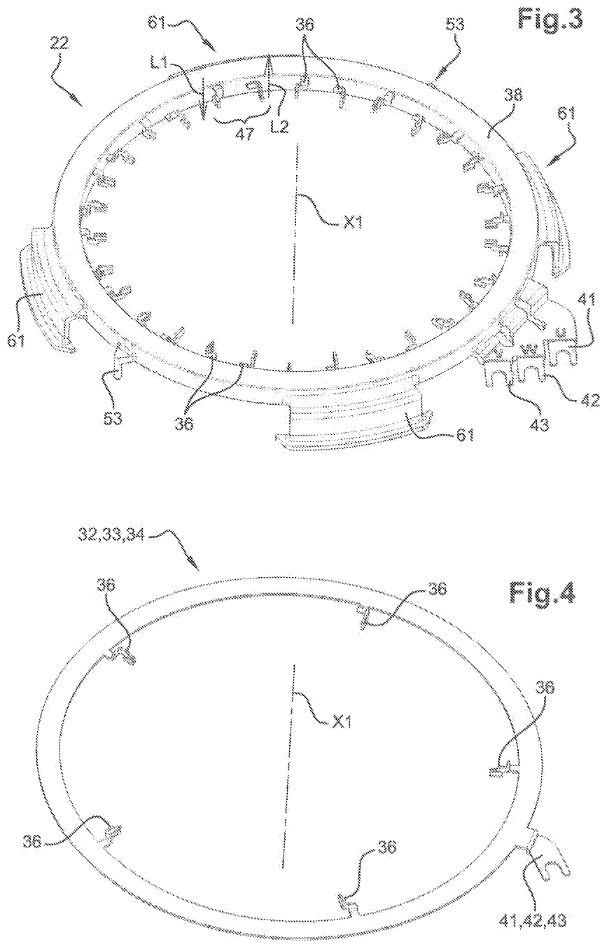

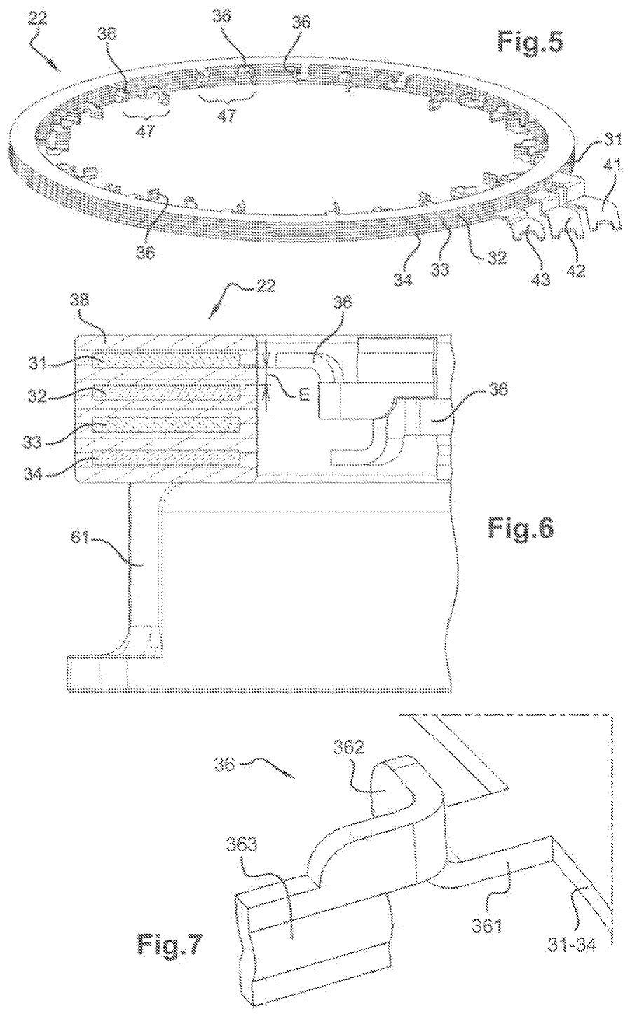

In the embodiments according to the invention, the interconnector comprises circular conductors with lugs, as in this aforementioned application. As in the preceding figures, the stator of the electrical machine can comprise a stator body 12 with a head 17 and teeth 14 which are separated by notches 15, as in FIG. 2a. This stator 11 supports coils 19 with input ends 191 and output ends 192. These coils 19 comprise a conductive wire which is wound around a notch insulator 20 as in FIGS. 2a to 2b, the cross-section of the wire being round, rectangular, square or another shape. The coils 19 are fitted on the teeth 14 via their insulator 20 as in the preceding figures. The insulator 20 in FIGS. 2a to 9 can globally be retained. The modification of this insulator concerns the fact that it is configured so that the inputs 191 and the outputs 192 of the coils are implanted respectively at one and the other of the axial ends of the coils 19, around a circumference which is at least equal to that of the inner periphery of the teeth 14. These ends 191, 192 are thus implanted axially on both sides of the body 12 of the stator 11.

Thus, according to the invention, an interconnector with circular conductors 31-34 for a stator of a polyphase rotary electrical machine comprising a stator 11 body 12 which supports a winding provided with a plurality of coils 19, each with input 191 and output 192 ends, is characterised in that it comprises a first part 22a comprising at least three circular conductors 32-34 with an annular form which are stacked axially on one another and insulated electrically against one another, and a second part 22b comprising at least one circular conductor 31 with an annular form which is insulated electrically, the said first and second parts being designed to be implanted on both parts of the body 12 of the stator, and in that the circular conductors 32-34 of the first part 22a and the circular conductor 31 of the second part 22b support on their inner periphery lugs 36 which extend projecting towards the interior for welding respectively of the input ends and output ends of the coils.

As in FIG. 2a, the first part 22a can comprise support which are designed to be supported on one of the rims of the head 17. This first part 22a can comprise indexing studs as in FIGS. 2a to 9.

These indexing studs can cooperate with guide means, such as protuberances, which belong to coil insulators 20 as in FIGS. 2a to 9.

The preceding information applies to the second part 22b of the interconnector which can thus be provided with support feet and indexing studs.

It is possible to standardise the coil insulators and provide them at each of their axial ends with guide hollows for receipt of an end of a coil and with protuberances for receipt of an indexing stud of the interconnector

In general, globally the structure of the notch insulators and their fitting on the teeth is retained. Thus, it is possible to proceed to secure insulators by means of impregnation as in the aforementioned application, before or after the welding of the lugs 36 on the ends 191, 192.

There is enough space to carry out the welding of the ends 191, 192 on the lugs 36, since the interconnector is divided into two dedicated parts, each at one of the ends 191, 192 of the coils, these two parts being arranged on both sides of the body of the stator. In addition, the ends 191, 192 of the coils are implanted around a circumference with a diameter which is at least equal to that of the inner periphery of the body 12 of the stator defined by the inner periphery of the teeth 14. During the fitting of the rotor in the stator axially in one direction or the other, there is therefore no danger of interference.

It is possible to implant the first part 22a on the front side of the body of the stator and the second part 22b on the rear side of the body 12. The inverse is possible.

There is no profound modification of the interconnector in FIGS. 2a to 9, this interconnector corresponding to the first part 22 of the interconnector according to the invention with one circular conductor less, with the circular conductors of the first part 22a as well as the circular conductor of the second part 22b being embedded in electrically insulating material, such as plastic material. The structure of the lugs 36 is retained, as can be seen in particular in FIG. 7.

In addition it is easily possible to increase the number of phases of the machine, with the first part 22a being able to comprise more than three circular conductors.

### First Embodiment

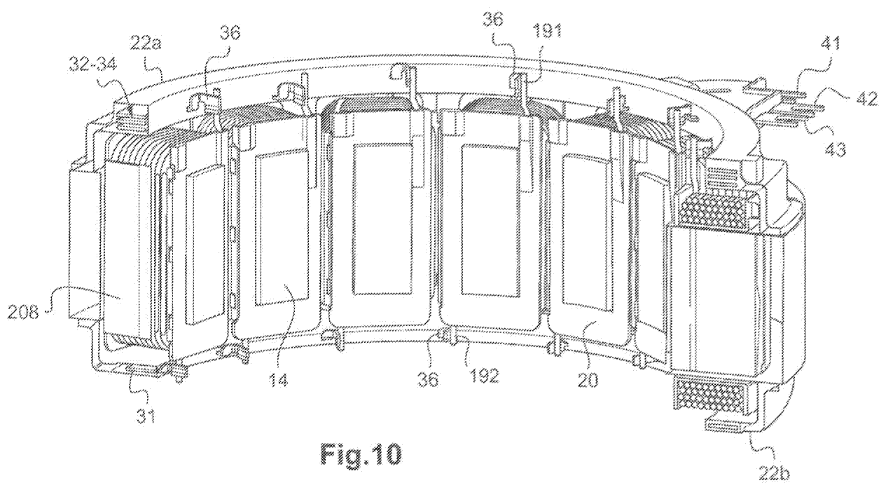

In this embodiment (FIG. 10), the frame 31 of the second part 22b is a neutral circular conductor for fitting in star form of the coils 19, of which in this case there are 15, as in FIGS. 2a to 2b. This second part can be provided with support feet on the edge concerned of the head. As a variant, this second part is without support feet. The circular conductor 31 is embedded in an electrically insulating material such as plastic material, for example PA 6.6, which can be reinforced by fibres.

The first part 22a has three circular conductors instead of four embedded in plastic material as in FIGS. 6. 41, 42 and 43 show the terminals of these circular conductors which are identical to those in FIGS. 2a to 9. In the aforementioned manner, this first part can comprise support feet on the other edge of the head.

It will be noted that the axial size of the interconnector is globally the same as that in FIGS. 2a to 9, since a circular conductor is transferred from one end of the body 12 to the other end of this body 12.

### Second Embodiment

In this second embodiment, the second part 22b comprises a number of circular conductors which is equal to that of the part 22a for fitting in the form of a triangle of the coils.

The first and second part of the interconnector can thus comprise at least three circular conductors with terminals for connection to the electronic part of the electrical machine, for example_by means of two cables.

### Other Embodiments

The second part of the interconnector can comprise two neutral circular conductors, and the first part of the interconnector can comprise six circular conductors for fitting in parallel of two windings in star form.

The number of phases of the machine can be more than 3, for example 4, 5 or 6 phases.

The number of coils 19 and teeth 14 can be more or less than 15 according to the power desired and number of phases required.

The notch insulator 20 can be without a heel 207 and/or a fin 208.

The insulator 20 can be in two transverse or axial parts which are assembled to one another for example by being snapped together.

The frame 202 of the insulator 20 can have longitudinally on each side a window for fitting of a narrow insulator which is in contact with the tooth 14 concerned, for better discharge of the calories.

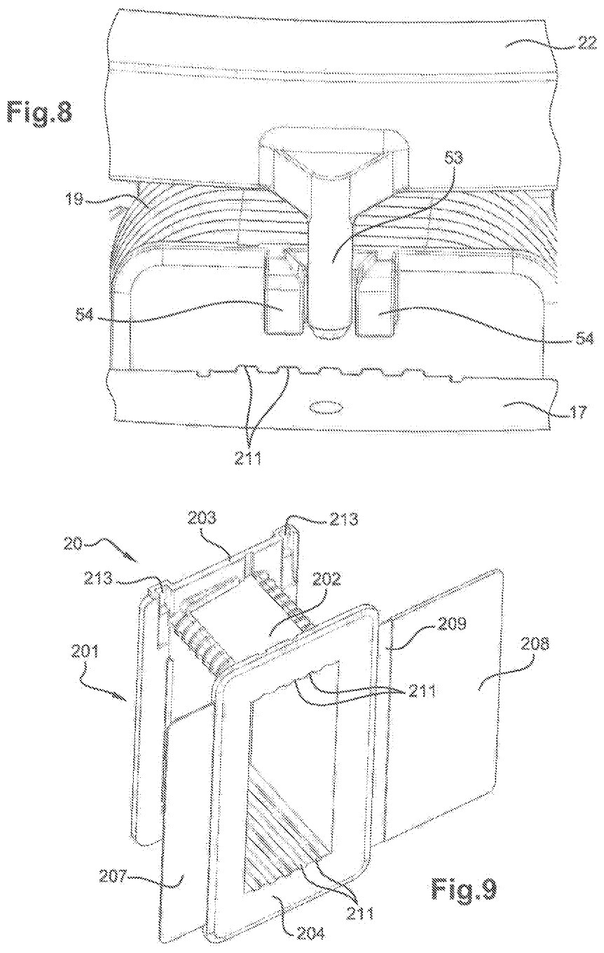

In order to guarantee efficient retention of the coil 19 on its tooth 14 during the injection of the varnish, it is possible to provide lugs for locking on the insulator 20 which cooperate with pits provided in the tooth, as in FIG. 8 of the application FR 12/58978 filed on 25 Sep. 2012 as can be seen in this application, by means of a system for snapping together with the longitudinal border of the front rim 203.

The teeth 14 can be added onto the head 17 by a connection of the tenon-mortise type. In this case, it is possible to fit the coil 19 in advance on its tooth 14 and the notches 15 can be of the semi-closed type, the teeth 14 then having feet.

It is possible to implant a temperature sensor in one of the coils 19 in order to cut off the electrical machine in the event of overheating.

All of these embodiments can be considered in isolation or in combination.

### Applications

The interconnector according to the invention can form part of a stator of a rotary electrical machine consisting in the aforementioned manner of an alternator, or an alternator-starter, or an electric motor, or an electromagnetic retarder.

The alternator can belong to a range extender of an electric vehicle, this alternator being associated with a thermal engine in order to form together with the latter a generating set to recharge the batteries of the electric vehicle. In this case, the alternator can be rotated by the output shaft of the thermal engine.

The alternator-starter or the alternator can be driven by the thermal engine of the vehicle via a movement transmission which can comprise at least one belt and one pulley integral with the shaft of the rotor.

The alternator-starter or the alternator can be associated with at least one clutch which is interposed between the thermal engine and the gearbox of the motor vehicle, as described for example in document FR 2 830 589 and in the application FR 12/58978 filed on 25 Sep. 2012, to which reference will be made for further details.

In the aforementioned manner, the rotor of the electrical machine can be a claw rotor, a rotor with projecting poles, or a rotor with permanent magnets. The permanent magnets can be implanted radially or circumferentially or in an inclined manner, as described in the aforementioned application FR 12/58978, which also describes a pipe for the cooling of the electrical machine.

The claw rotor and the rotor with projecting poles can also be provided with permanent magnets in the aforementioned manner.

In all cases, by means of the provisions according to the invention, it is possible to fit the rotor in the stator axially in both directions.

The terms conductors or electrical conductors or electrical tracks are used in invariably and are synonymous throughout the description.

1-20. (canceled)

21. An interconnector (22) for a stator (11) of a polyphase rotary electrical machine, the stator (11) comprising a stator body (12) supporting a winding including a plurality of coils (19), each of the coils (19) having input (191) and output (192) ends, the interconnector (22) comprising:
a first part (22a) comprising at least three phase conductors (32-34) each having an annular form, the at least three phase conductors (32-34) stacked axially on one another and insulated electrically against one another; and
a second part (22b) comprising at least one neutral conductor (31) having an annular form and insulated electrically;
the first part (22a) and the second part (22b) mounted on axially opposite sides of the stator body (12), each of the at least three annular phase conductors (32-34) of the first part (22a) and the at least one annular neutral conductor (31) of the second part (22b) provided on an inner periphery thereof with lugs (36) projecting towards an interior of the interconnector (22) for welding respectively of the input ends (191) and the output ends (192) of the coils
the first part (22a) of the interconnector having an L-shaped support feet (61) configured to be supported on a rim of a head (17) of the body (12) of the stator (11).

22. The interconnector according to claim 1, wherein the annular neutral conductor (31) of the second part (22b) is configured for electrical coupling of the coils (19) in a star form.

23. The interconnector according to claim 1, wherein the second part (22b) of the interconnector comprises two annular neutral conductors (31) for electrical coupling in parallel of two windings of the coils in a star form.

24. The interconnector according to claim 1, wherein the first part (22a) of the interconnector comprises more than three annular phase conductors.

25. The interconnector according to claim 1, wherein the second part (22b) of the interconnector has a number of annular neutral conductors which is equal to a number of the annular phase conductors of the first part (22a) of the interconnector for electrical coupling of the coils in a star form.

26. The interconnector according to claim 1, wherein the L-shaped support feet (61) has a support 62 configured to be supported on the rim of the head (17) of the body (12) of the stator (11).

27. The interconnector according to claim 1, wherein the second part (22b) of the interconnector has an L-shaped support feet (61) configured to be supported on an other rim of the head (17) of the body (12) of the stator (11).

28. The interconnector according to claim 1, wherein the interconnector is secured on at least one coil insulator.

29. The interconnector according to claim 8, wherein the interconnector is secured on at least three coil insulators.

30. The interconnector according to claim 1, wherein the coils are coupled in the form of a triangle.

31. A stator (11) of a rotary electrical machine comprising a stator body (12), supporting a winding provided with a plurality of coils (19) each having input and output ends (191, 192), wherein the input and output ends (191, 192) are connected to an interconnector (22a, 22b) according to claim 1.

32. The stator (11) according to claim 12, wherein the input and output ends (191, 192) of the coils (19) are implanted respectively at one and the other of axial ends of the coils.

33. The stator (11) according to claim 12, wherein the input and output ends (191, 192) of the coils are implanted on both axially opposite sides of the body (12) of the stator.

34. The stator (11) according to claim 12, wherein the input and output ends (191, 192) of the coils (19) are implanted on a circumference which is at least equal to a circumference of an inner periphery of the body (12) of the stator.

35. The interconnector according to claim 2, wherein the first part (22a) of the interconnector comprises more than three phase conductors.

36. The interconnector according to claim 3, wherein the first part (22a) of the interconnector comprises more than three phase conductors.

37. The interconnector according to claim 2, wherein the second part (22b) of the interconnector has a number of annular neutral conductors which is equal to a number of the annular phase conductors of the first part (22a) of the interconnector for electrical coupling of the coils in a star form.

38. The interconnector according to claim 3, wherein the second part (22b) of the interconnector has a number of annular neutral conductors which is equal to a number of the annular phase conductors of the first part (22a) of the interconnector for electrical coupling of the coils in a star form.

39. The interconnector according to claim 4, wherein the second part (22b) of the interconnector has a number of annular neutral conductors which is equal to a number of the annular phase conductors of the first part (22a) of the interconnector for electrical coupling of the coils in a star form.
